(19) United States
(12) Patent Application Publication
(10) Pub. No.: US 2007/0033017 A1
(43) Pub. Date: Feb. 8, 2007

(54) Spoken language proficiency assessment by computer

(75) Inventors: Anish Nair, Fremont, CA (US); Matthew Lennig, Palo Alto, CA (US); Brent Townshend, Menlo Park, CA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Ordinate Corporation, Menlo Park, CA (US)

(21) Appl. No.: 11/490,290

(22) Filed: Jul. 20, 2006

Related U.S. Application Data
(60) Provisional application No. 60/701,192, filed on Jul. 20, 2005.

(51) Int. Cl. G10L 19/00

(52) U.S. Cl. 704/219

(57) ABSTRACT

A system and method for spoken language proficiency assessment by a computer is described. A user provides a spoken response to a constructed response question. A speech recognition system processes the spoken response into a sequence of linguistic units. At training time, features matching a linguistic template are extracted by identifying matches between a training sequence of linguistic units and pre-selected templates. Additionally, a generalized count of the extracted features is computed. At runtime, linguistic features are detected by comparing a runtime sequence of linguistic units to the feature set extracted at training time. This comparison results in a generalized count of linguistic features. The generalized count is then used to compute a score.

### RELATED APPLICATIONS

The present patent application claims priority under 35 U.S.C. § 119(e) to U.S. Provisional Patent Application Ser. No. 60/701,192, which was filed Jul. 20, 2005. The full disclosure of U.S. Provisional Patent Application Ser. No. 60/701,192 is incorporated herein by reference.

### FIELD

The present invention relates generally to language assessment, and more particularly, relates to spoken language proficiency assessment using computer based techniques.

### BACKGROUND

For many years, standardized tests have been administered to examinees for a variety of reasons, such as for educational testing or skill evaluation. Many standardized tests require a test taker to provide a response to a constructed response question. A constructed response question may be a question or a directive to respond that does not provide a response alternative (like a multiple choice question) and requires the test taker to self-generate a response. For example, high school students may take Advanced Placement (AP) examinations that, if successful, may permit the student to receive college credit. As another example, law school graduates may take one or more state bar examinations to become a licensed attorney in that state. Both the AP examinations and the bar examinations may include constructed response questions, such as essay questions. Constructed response questions may also require the test taker to provide a spoken response, such as during an oral examination.

Responses to these constructed response questions are typically graded by one or more human graders or evaluators. The effort to grade the responses to constructed response questions can be enormous, especially when a question is graded by multiple evaluators. Computer-based automatic scoring systems may provide a quicker method for grading responses to constructed response questions. Some attempts have been made to automate the grading of written materials, such as essay responses. However, not all responses are written.

Thus, it would be beneficial to make the process of grading spoken responses to constructed response questions more efficient without sacrificing the consistency of the scores.

### SUMMARY

A method and system for spoken language proficiency assessment is described. The method includes receiving a runtime spoken response to a constructed response question, converting the runtime spoken response into a runtime sequence of linguistic units, comparing the runtime sequence of linguistic units to a linguistic feature set, computing a generalized count of at least one feature in the linguistic feature set that is in the runtime spoken response, and computing a score based on the generalized count. A speech recognition system may be used to receive and convert the runtime spoken response into the runtime sequence of linguistic units.

The method may also include generating the linguistic feature set. Generating the linguistic feature set may include comparing a training spoken response to at least one linguistic template. The at least one linguistic template may be selected from the group consisting of W₁, W₂W₃, W₄W₅W₆, W₇W₈W₉W₁₀, W₁₁X₁W₁₂, and W₁₃X₂W₁₄X₃W₁₅, where Wᵢ for i≧1 represents any linguistic unit and Xᵢ for i≧1 represents any sequence of linguistic units of length greater than or equal to zero. In another example, the linguistic feature set may be generated by receiving a training spoken response to the constructed response question, converting the training spoken response into a training sequence of linguistic units, comparing the training sequence of linguistic units to at least one linguistic template, and computing a generalized count of at least one feature in the training spoken response that matches the at least one linguistic template.

The system for assessing spoken language proficiency includes a processor, data storage, and machine language instructions stored in the data storage executable by the processor to: receive a spoken response to a constructed response question, convert the spoken response into a sequence of linguistic units, compare the sequence of linguistic units to a linguistic feature set, compute a generalized count of at least one feature in the linguistic feature set that is in the spoken response, and compute a score based on the generalized count.

These as well as other aspects and advantages will become apparent to those of ordinary skill in the art by reading the following detailed description, with reference where appropriate to the accompanying drawings. Further, it is understood that this summary is merely an example and is not intended to limit the scope of the invention as claimed.

### BRIEF DESCRIPTION OF THE DRAWINGS

Presently preferred embodiments are described below in conjunction with the appended drawing figures, wherein like reference numerals refer to like elements in the various figures, and wherein:

FIG. 1 is a block diagram of a system for processing and assessing spoken language responses, according to an example;

FIG. 2 is a block diagram of a system for processing spoken language responses at training time, according to an example;

FIG. 3 is a flow diagram of a method for processing spoken language responses at training time, according to an example;

FIG. 4 is a block diagram of a system for assessing spoken language responses at runtime, according to an example; and

FIG. 5 is a flow diagram of a method for assessing spoken language responses at runtime, according to an example.

### DETAILED DESCRIPTION

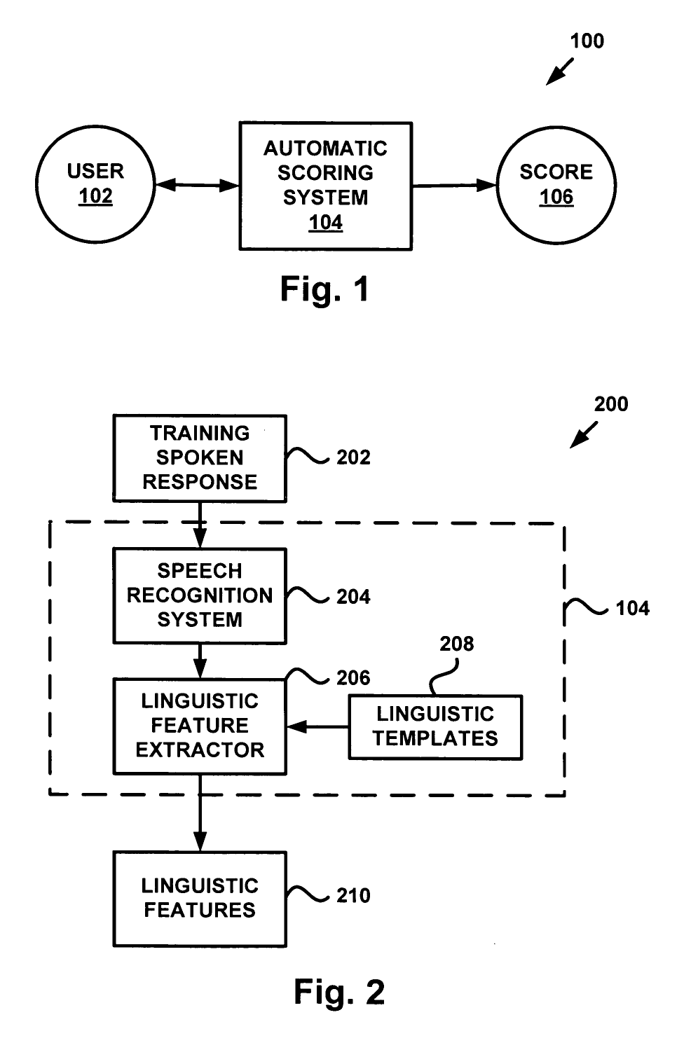

FIG. 1 is a block diagram of a system 100 for processing and assessing spoken language responses. Generally, the system 100 is used at training time and runtime, which are described in more detail with respect to FIGS. 2-5. The system 100 includes an automatic scoring system 104. The automatic scoring system 104 may be a general purpose computer system having any combination of hardware, software, and/or firmware. Alternatively, the automatic scoring system 104 may be custom designed for processing and assessing spoken language responses.

The automatic scoring system 104 receives an input from a user 102. The input from the user 102 may be a spoken response to a constructed response question. The constructed response question may also be referred to as an “item”. The constructed response question may be provided to the user 102 by the automatic scoring system 104. Alternatively, the user 102 may receive the constructed response question from another source.

The user 102 may be any person providing a spoken response to the automatic scoring system 104. For example, at training time, the user 102 may be a person that provides training responses to the automatic scoring system 104. As another example, at runtime, the user 102 may be a student (child or adult) in a formal educational program, someone who is taking an entrance or proficiency test, or someone who is merely interested in evaluating his or her skills.

The user 102 may access the automatic scoring system 104 using a landline telephone, a mobile telephone, a computer, a microphone, a voice transducer, or any other communication device able to transmit voice signals. The connection between the user 102 and the automatic scoring system 104 depends on the type of communication device being used. For example, the connection between the user 102 and the automatic scoring system 104 may be a wired or wireless connection using a telecommunication network and/or a data information network.

At runtime, the automatic scoring system 104 may provide a score 106 based on the input from the user 102. The score 106 may be provided to the user 102 or to another person and/or entity, such as to a teacher or an educational institution. The score 106 may be provided to the user 102 or other person/entity via an output device. For example, the score 106 may be presented on a display via the Internet. As another example, the score 106 may be printed on a printer connected (wired or wirelessly) to the automatic scoring system 104. As yet another example, if the user 102 has accessed the automatic scoring system 104 using a telephone, the automatic scoring system 104 may provide the score 106 to the user 104 verbally using an interactive voice response unit.

FIG. 2 is a block diagram of a system 200 for processing spoken language responses at training time. Training time is used to train the automatic scoring system 104 to assess spoken language proficiency of the user 102 at runtime. The system 200 includes a training spoken response input 202, the automatic scoring system 104, and a linguistic features output 210. The automatic scoring system 104 includes a speech recognition system 204, a linguistic feature extractor 206, and one or more linguistic templates 208.

The training spoken response input 202 is provided by at least one person (herein referred to as “the training subjects”) at training time of the automatic scoring system 104. For each item that will be used to assess spoken language proficiency at runtime, the training subjects provide at least one spoken response to the automatic scoring system 104. The training subjects may provide a spoken response for a set of items.

Preferably, more than one training subject may be used to provide a spoken response to the set of items. The training subjects may be selected with reference to a distribution of demographic, linguistic, physical or social variables that can have a salient effect on the form or content of speech as received by the speech recognition system 204. These demographic, linguistic, physical, or social variables include the training subjects' age, size, gender, sensory acuity, ethnicity, dialect, education, geographic origin or current location, socioeconomic status, employment, or professional training. Speech samples may also be selected according to the time of day at the training subjects' location, the type and condition of the signal transducer, and the type and operation of the communication channel.

The speech recognition system 204 may be capable of receiving the speech of the user 102 and converting the speech into a sequence of linguistic units. The sequence of linguistic units is a machine-readable representation indicative of a word or words actually spoken. The speech recognition system 204 may be any combination of software, hardware, and/or firmware.

Preferably, the speech recognition system 204 is implemented in software. For example, the speech recognition system 204 may be the HTK software product, which is owned by Microsoft and is available for free download from the Cambridge University Engineering Department's web page (http://htk.eng.cam.ac.uk). As another example, the speech recognition system 204 may be one of the speech recognition systems provided by Nuance Communications, Inc.

The speech recognition system 204 may also include or be implemented with linguistic parsing software, such as MXPOST, to convert the words to higher order linguistic units, which allows for syntactic analysis. The linguistic parsing software may also provide lower order linguistic units, such as syllables, morphemes, and phonemes.

The linguistic feature extractor 206 receives the sequence of linguistic units from the speech recognition system 204. The linguistic feature extractor 206 may be any combination of software, hardware, and/or firmware. Preferably, the linguistic feature extractor 206 is implemented in software.

The linguistic feature extractor 206 compares the sequence of linguistic units from the speech recognition system 204 to the linguistic templates 208 to generate linguistic features. The linguistic templates 208 may be stored in a database or other data structure in the automatic scoring system 104. Preferably, the linguistic templates 208 stored in the database are selected prior to training time and identify sets of features to be extracted by the linguistic feature extractor 206.

Following are examples of templates, where Wᵢ represents any linguistic unit, Xᵢ represents any sequence of linguistic units of length greater than or equal to zero, and i≧1:
W₁ (all monograms)
W₂ W₃ (all bigrams)
W₄ W₅ W₆ (all trigrams)
W₇ W₈ W₉ W₁₀ (all quadgrams)
W₁₁ X₁ W₁₂ (all bi-ordergrams)
W₁₃ X₂ W₁₄ X₃ W₁₅ (all tri-ordergrams)
   A monogram includes a single linguistic unit, a bigram includes a sequence of two linguistic units, a trigram includes a sequence of three linguistic units, and a quadgram includes a sequence of four linguistic units. A bi-ordergram includes two linguistic units separated by a sequence of linguistic units that match anything. Accordingly, the Xᵢ in the ordergrams above may be considered as a “wildcard”. Similar to a bi-ordergram, the tri-ordergram is a sequence of three linguistic units each separated by a wildcard.

The linguistic feature extractor 206 extracts and quantifies occurrences of linguistic features. The quantification is a generalized count of a linguistic feature. The generalized count is any function of the number of occurrences of that feature in the response, such as the actual number of occurrences or a mathematical transformation of the actual number of occurrences, such as a log, a multiple, or an increment/decrement of the number of occurrences. As another example, the generalized count may be the presence versus absence of the feature in the response. The quantification may be a generalized count of any kind of linguistic unit including, but not limited to, a distinctive feature, a segment, a phoneme, a syllable, a morpheme, a word, a syntactic phrase, a syntactic constituent, a collocation, a phonological phrase, a sentence, a paragraph, and an extended passage.

A feature is an instance of a template if it matches that template. A feature matches the template if the feature corresponds to the format of the template. For example, “in the” is an instance of the template W₁ W₂, where Wᵢ is a word unit and i≧1.

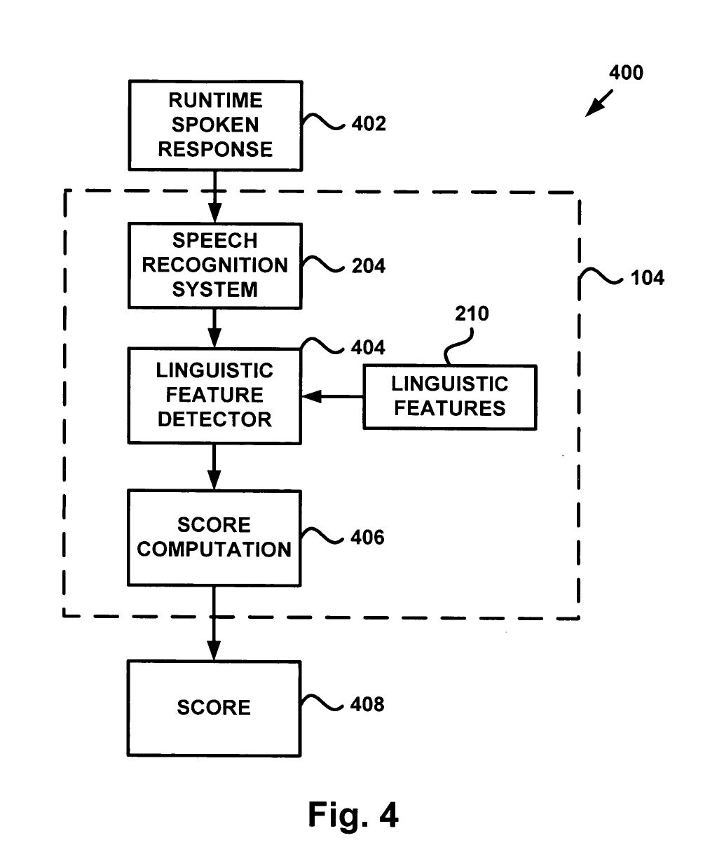

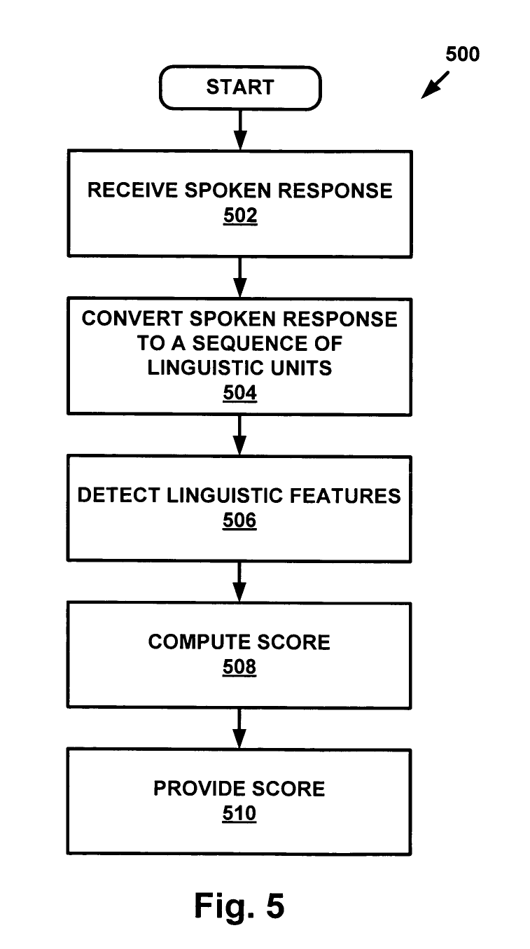

The extracted features and the generalized counts for each feature in each response in a training set are provided as the linguistic features output 210. The linguistic features output 210 may include an item-specific feature set and generalized counts for each feature over all responses in the training set. The automatic scoring system 104 uses the linguistic features output 210 at runtime as described with reference to FIGS. 4-5.

At training time, the automatic scoring system 104 may perform additional operations. For example, the linguistic feature extractor 206 may also extract linguistic features and generalized counts from a set of one or more expected responses to the item to enrich the training set. The expected responses may include one or more correct or incorrect answers.

As another example, the automatic scoring system 104 may transform generalized counts into a vector space of reduced dimensionality for features that conform to the following feature templates:
W₁
W₂ W₃
   Other feature templates may also be used.

At training time, the automatic scoring system 104 may apply a function whose parameters have been estimated to map points in the reduced dimensionality vector space into proficiency estimates. The parameters may have been estimated from training data. The training data may consist of human judgments on a set of responses together with their corresponding points in the reduced dimensionality vector space.

The automatic scoring system 104 may compute a subset of the feature set generated at training time, all of whose features match a feature template. The automatic scoring system 104 may detect a set of shared features that occur both in a response and in the subset. The automatic scoring system 104 may compute a ratio of the sum of generalized counts of the shared features to the sum of generalized counts of the features in the response matching the feature template. This ratio may be computed for each of the following feature templates:
W₁
W₂ W₃
W₄ W₅ W₆
W₇ W₈ W₉ W₁₀
   Other feature templates may also be used. The automatic scoring system 104 may also compute the score 106 of the training spoken response 202 as the geometric average of the above computed ratios.

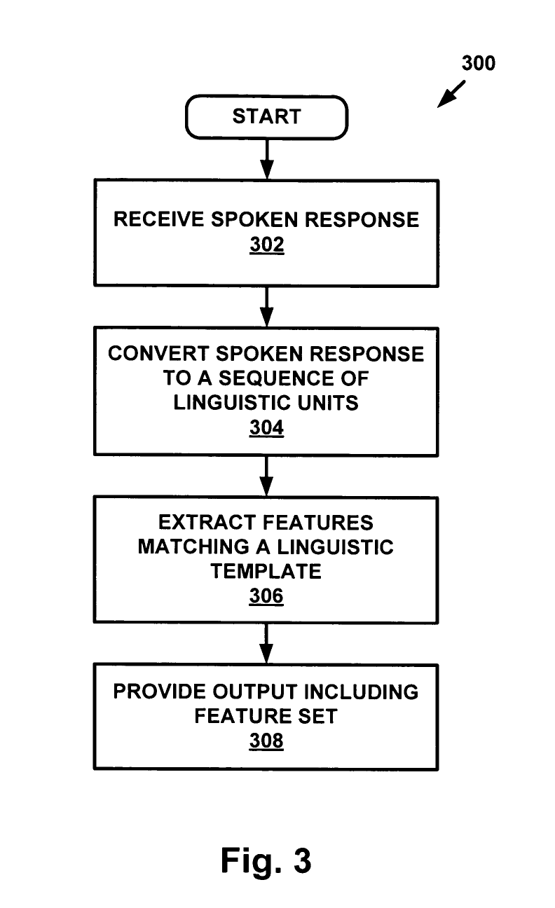

FIG. 3 is a flow diagram of a method 300 for processing spoken language responses at training time. At block 302, a spoken response is received. The spoken response may be a response to a constructed response question. At training time, the user 102 may preferably provide an unscripted spoken response. However, the user 102 may instead provide a spoken response that has been previously scripted.

At block 304, the spoken response is converted to a sequence of linguistic units by any known or developed speech recognition system or program. At block 306, features matching a linguistic template are extracted by identifying matches between the sequence of linguistic units and pre-selected templates. In addition to extracting matching features, a generalized count of the extracted features is performed. At block 308, a feature set is provided as an output. The feature set includes the extracted features and generalized counts.

FIG. 4 is a block diagram of a system 400 for assessing spoken language responses at runtime. At runtime, the automatic scoring system 104 assesses a person's spoken language proficiency. The system 400 includes a runtime spoken response input 402, the automatic scoring system 104, and a score output 408. The automatic scoring system 104 includes the speech recognition system 204, a linguistic feature detector 404, a score computation 406, and the linguistic features 210 identified at training time.

The runtime spoken response input 402 is provided by a person (herein referred to as “the test subject”) at runtime. The test subject may be any person. The test subject provides a spoken response to a constructed response question. The test subject may receive the constructed response question from the automatic scoring system 104 or another source.

The speech recognition system 204 processes the speech of the test subject responding to the constructed response question and provides a sequence of linguistic units to the linguistic feature detector 404. The linguistic feature detector 404 may be any combination of software, hardware, and/or firmware. Preferably, the linguistic feature detector 404 is implemented in software.

The linguistic feature detector 404 compares the sequence of linguistic units from the speech recognition system 204 with the linguistic features 210 extracted at training time. As a result of this comparison, the linguistic feature detector 404 may obtain a generalized count of how many of each of the features in the feature set 210 were in the runtime spoken response 402.

The score computation 406 transforms the generalized count into the score 408. Alternatively, the generalized count may be provided as the score 408. The score 408 may represent an assessment of the subject's spoken language proficiency. The score computation 406 may be any combination of software, hardware, and/or firmware. Preferably, the score computation 406 is implemented in software.

The score computation 406 may analyze the generalized count using statistical analysis techniques. For example, the score computation 406 may transform the generalized counts from the linguistic feature detector 404 into a vector space of reduced dimensionality for features that conform to the following feature templates:
W₁
W₂ W₃
   Other templates may also be used.

The score computation 406 may apply a function whose parameters have been estimated at training time to map points in the reduced dimensionality vector space into proficiency estimates. The parameters may have been estimated from training data. The training data may consist of human judgments on a set of responses together with their corresponding points in the reduced dimensionality vector space.

The score computation 406 may compute a subset of the feature set generated at training time, all of whose features match a feature template. The score computation 406 may detect a set of shared features that occur both in a response and in the subset. The score computation 406 may compute a ratio of the sum of generalized counts of the shared features to the sum of generalized counts of the features in the response matching the feature template. This ratio may be computed for each of the following feature templates:
W₁
W₂ W₃
W₄ W₅ W₆
W₇ W₈ W₉ W₁₀
   Other templates may also be used. The score computation 406 may also compute the score 106 of the runtime spoken response 402 as the geometric average of the above computed ratios.

The score computation 406 may also compute the number of features detected in the runtime spoken response 402 normalized by the length of the response. Preferably, this computation may be performed for features that conform to the feature template W₁X₁W₂. However, other templates may also be used.

FIG. 5 is a flow diagram of a method 500 for assessing spoken language responses at runtime. At block 502, a spoken response is received. The spoken response is a response to a constructed response question. At block 504, the spoken response is converted to a sequence of linguistic units by any known or developed speech recognition system or program.

At block 506, linguistic features are detected by comparing the sequence of linguistic units from the speech recognition system 204 to the feature set extracted at training time. This comparison results in a generalized count of linguistic features. At block 508, the generalized count is used to compute the score 408. Preferably, the score may be computed using dimensionality reduction and regression techniques. At block 510, the score is provided to the test subject or another interested party.

The system and method for assessing spoken language proficiency may be illustrated using an example. In this example, the test subject dials a predetermined telephone number in order to take a spoken language proficiency test. Once a connection is established, the automatic scoring system 104 provides directions to the test subject over the telephone and the test subject provides responses. For example, the automatic scoring system 104 may ask the test subject to retell a story.

An example story is: “A boy is going to cross the street when a man sees a car approaching. The man yells ‘careful’ and grabs the boy by the arm just in time. The boy is so scared that the man crosses the street with the boy and buys him an ice cream cone to calm him down.” If the test subject repeats the story as: “A boy is going to cross the street and a man speeding in his car yells ‘careful’”, the automatic scoring system 104 identifies that the test subject did not repeat the story completely or accurately. Additionally, the automatic scoring system 104 provides the score 408 based on the response.

Table 1 shows the extracted features and their associated generalized counts for this example. The score calculated by the automatic scoring system 104 is 2.85, which is comparable to a human grader score of 2.33. As described, the automatic scoring system 104 provides a grade for a spoken response to constructed response question more efficiently than a human grader without sacrificing the consistency of the scores.

TABLE 1
Feature Set and Associated Generalized Counts

| | | | |
|---|---|---|---|
| Careful | .20 | the boy | .09 |
| boy | .16 | speed | .08 |
| calm | .14 | high speed | .05 |
| cross | .13 | yells | .04 |
| cross the | .10 | man | .03 |
| car | .09 | yells careful | .03 |

It should be understood that the illustrated embodiments are examples only and should not be taken as limiting the scope of the present invention. The claims should not be read as limited to the described order or elements unless stated to that effect. Therefore, all embodiments that come within the scope and spirit of the following claims and equivalents thereto are claimed as the invention.

We claim:

1. A method for assessing spoken language proficiency, comprising in combination:
receiving a runtime spoken response to a constructed response question;
converting the runtime spoken response into a runtime sequence of linguistic units;
comparing the runtime sequence of linguistic units to a linguistic feature set;
computing a generalized count of at least one feature in the linguistic feature set that is in the runtime spoken response; and
computing a score based on the generalized count.

2. The method of claim 1, wherein a speech recognition system receives and converts the runtime spoken response into the runtime sequence of linguistic units.

3. The method of claim 1, further comprising generating the linguistic feature set.

4. The method of claim 3, wherein generating the linguistic feature set includes comparing a training spoken response to at least one linguistic template.

5. The method of claim 4, wherein the at least one linguistic template is selected from the group consisting of W₁, W₂W₃, W₄W₅W₆, W₇W₈W₉W₁₀, W₁₁X₁W₁₂, and W₁₃X₂W₁₄X₃W₁₅, where Wᵢ for i≧1 represents any linguistic unit and X₁ for i≧1 represents any sequence of linguistic units of length greater than or equal to zero.

6. The method of claim 1, wherein the linguistic feature set is generated by
receiving a training spoken response to the constructed response question;
converting the training spoken response into a training sequence of linguistic units;
comparing the training sequence of linguistic units to at least one linguistic template; and
computing a generalized count of at least one feature in the training spoken response that matches the at least one linguistic template.

7. The method of claim 6, wherein a speech recognition system receives and converts the training spoken response into the training sequence of linguistic units.

8. The method of claim 6, wherein the at least one linguistic template is selected from the group consisting of W₁, W₂W₃, W₄W₅W₆, W₇W₈W₉W₁₀, W₁₁X₁W₁₂, and W₁₃X₂W₁₄X₃W₁₅, where Wᵢ for i≧1 represents any linguistic unit and Xᵢ for i≧1 represents any sequence of linguistic units of length greater than or equal to zero.

9. The method of claim 6, further comprising transforming the generalized count of at least one feature in the training spoken response into a vector space of reduced dimensionality.

10. The method of claim 9, wherein the at least one feature in the linguistic feature set conforms to at least one of feature templates W₁ and W₂W₃, where Wᵢ for i≧1 represents any linguistic unit.

11. The method of claim 1, wherein computing the score includes transforming the generalized count of at least one feature in the linguistic feature set that is in the runtime spoken response into a vector space of reduced dimensionality.

12. The method of claim 11, wherein the at least one feature in the linguistic feature set conforms to at least one of feature templates W₁ and W₂W₃, where Wᵢ for i≧1 represents any linguistic unit.

13. The method of claim 11, wherein transforming the generalized count into a vector space of reduced dimensionality includes applying a function whose parameters have been estimate at training time to map points in the reduced dimensionality vector space into proficiency estimates.

14. The method of claim 1, wherein computing the score includes calculating a ratio of a sum of generalized counts of shared features that occur in a response and a subset of the linguistic feature set corresponding to one template to a sum of generalized counts of the features in the response matching a feature template.

15. The method of claim 14, wherein the ratio is calculated for at least one of the feature templates W₁, W₂W₃, W₄W₅W₆, and W₇W₈W₉W₁₀, where Wᵢ for i≧1 represents any linguistic unit.

16. The method of claim 15, wherein computing the score includes computing a geometric average of the ratios calculated for the feature templates W₁, W₂W₃, W₄W₅W₆, and W₇W₈W₉W₁₀, where Wᵢ for i≧1 represents any linguistic unit.

17. The method of claim 1, wherein computing the score includes computing a generalized count of a number of features detected in the runtime spoken response normalized by a length of the runtime spoken response.

18. The method of claim 1, further comprising providing the score to at least one person or entity.

19. A system for assessing spoken language proficiency, comprising in combination:
a processor;
data storage; and
machine language instructions stored in the data storage executable by the processor to:
receive a spoken response to a constructed response question;
convert the spoken response into a sequence of linguistic units;
compare the sequence of linguistic units to a linguistic feature set;
compute a generalized count of at least one feature in the linguistic feature set that is in the spoken response; and
compute a score based on the generalized count.

20. The system of claim 19, further comprising machine language instructions stored in the data storage executable by the processor to generate the linguistic feature set.

21. The system of claim 19, further comprising machine language instructions stored in the data storage executable by the processor to provide the score to at least one person or entity.
